(19) United States
(12) Patent Application Publication
(10) Pub. No.: US 2014/0255557 A1
(43) Pub. Date: Sep. 11, 2014

(54) Methods of Preparing a Bakery Foodstuff Convenience Food Having Organoleptic Profile Comparable to Conventional Oven Baked Goods and Related Bakery Foodstuffs

(71) Applicant: Jonathan Liss, Philadelphia, PA (US)

(72) Inventor: Jonathan Liss, Philadelphia, PA (US)

(21) Appl. No.: 14/201,048

(22) Filed: Mar. 7, 2014

Related U.S. Application Data
(60) Provisional application No. 61/774,476, filed on Mar. 7, 2013.

(51) Int. Cl. A21D 13/00

(52) U.S. Cl. CPC A21D 13/0009
USPC 426/94; 426/243

(57) ABSTRACT

The invention includes methods of preparing a consumable on demand, warm bakery foodstuff. The method includes preparing a coating fluid; forming a baked good from a bakery mixture by applying ambient heat, maintaining the baked good within the container for a determinate amount of time at a first temperature, exposing the baked good within the container to microwave energy or to heat for a duration of time sufficient to bring at least the baked good from a second temperature to a final temperature of at least about 100° F., inverting the container to release the baked good through the top area of the container and the coating liquid, wherein upon inversion, the coating liquid forms a coating on the inverted baked good. The baked good and for coating liquid each independently has: an aw of about 0.65 to about 0.95 and a moisture content of about 10% to about 30%.

### CROSS-REFERENCE TO RELATED APPLICATION

This application claims the benefit of priority under 35 U.S.C. §119(e) to U.S. Provisional Patent Application No. 61/774,476, filed Mar. 7, 2013 and entitled, “Methods of Preparing a Bakery Foodstuff Convenience Food Having Organoleptic Profile Comparable to Conventional Oven Baked Goods and Related Bakery Foodstuffs,” the entire disclosure of which is incorporated herein by reference.

### BACKGROUND OF THE INVENTION

Freshly baked foods, such as sticky buns, cakes, and rolls, are always appreciated by consumers but few people have the time or inclination to prepare homemade baked goods, except for special occasions. Attempts have been made to develop shelf-stable bakery products that can be prepared quickly in the microwave. Such attempts have met with minimal success, as consumers tend to report that such baked goods lack the organoleptic properties of authentic conventionally baked foodstuffs. Accordingly, there remains a need in the art for methods of preparation of baked goods that can be quickly and conveniently heated using a rapid cook device, such as a microwave oven, yet which exhibit taste, texture and aroma profiles comparable to conventional freshly baked goods.

### BRIEF SUMMARY OF THE INVENTION

The invention includes methods of preparing a consumable on demand, warm bakery foodstuff. The method includes preparing a coating fluid; forming a baked good from a bakery mixture by applying ambient heat, wherein the baked good is disposed in a container comprising at least a bottom panel and a top area through which the baked good is accessible and having disposed upon a top surface of the bottom panel a determinate amount of a coating fluid; (c) maintaining the baked good within the container for a determinate amount of time at a first temperature; (d) exposing the baked good within the container to microwave energy or to heat for a duration of time sufficient to bring at least the baked good from a second temperature to a final temperature of at least about 100° F.; (e) inverting the container to release the baked good through the top area of the container and the coating liquid, wherein upon inversion, the coating liquid forms a coating on the inverted baked good. The baked good and/or coating liquid each independently has: an a_{w} of about 0.65 to about 0.95 and a moisture content of about 10% to about 30%.

Also included are methods of manufacture of a consumable on demand, warm bakery foodstuff comprising (a) preparing a coating fluid; (b) forming a baked good from a bakery mixture by applying ambient heat, wherein the baked good is disposed in a container comprising at least a bottom panel and a top area through which the baked good is accessible and having disposed upon a top surface of the bottom panel a determinate amount of coating fluid; (c) maintaining the baked good within the container for a determinate amount of time. Upon exposure to microwave energy or heat and removal from the container by inversion of the container, the baked good exhibits organoleptic properties comparable to a conventional freshly baked bakery foodstuff. Related bakery foodstuffs are also included.

### DETAILED DESCRIPTION OF THE INVENTION

The invention described herein includes methods of preparing a warm bakery foodstuff, particularly a sticky bun, which possesses a taste, aroma and texture organoleptic profile comparable to a fresh-from-the-conventional-oven foodstuff but is available “on demand”, e.g., within a few minutes or less in the microwave oven or other rapid cook device. Also included are bakery foodstuffs that can be prepared for consumption on demand, and other related methods.

The method of preparation includes the threshold steps of preparing a coating fluid and a baked good. By “coating fluid,” it is meant an edible fluid of any viscosity (including a gel like substance) that is capable of forming a layer or coating by flowing over the top and sides of the baked good when exposed to gravitational force (for example, when the baked good and coating liquid are released from the container by inversion, as described below). Preferably, the viscosity of the coating liquid is about 3,000 to about 15,000 cps, about 5,000 to about 10,000 cps or about 7,000 to about 9,000 cps at 100° F. to 160° F.

The coating fluid may be a confectionary sauce, an icing, or a savory sauce. Examples of coating fluids include, without limitation, a gravy, a caramel sauce, a vanilla sauce, a fruit sauce, a chocolate sauce, a butter sauce, a garlic sauce, an olive oil sauce, a brandy sauce, a hollandaise sauce, a béarnaise sauce, an alfredo sauce, and other cream based or tomato/fruit based sauces, either sweet or savory depending on the end product foodstuff to be prepared.

The coating fluid may be of any formulation or recipe known or to be developed in the art. In some embodiments, it may be preferred that the coating fluid and the baked good are each formulated such that, upon exposure to microwave energy, each increases in temperature at substantially the same rate so that upon removal from the microwave oven, each is independently substantially the same temperature.

The baked good of the invention may include any known or to be developed, although leavened baked goods, such as yeast breads or other goods leavened chemically or mechanically, such as baking soda leavened cakes, may be preferred. The baked good is prepared from a bakery mixture, which includes any of the ingredients necessary to form the final baked good in any proportion. As used herein, the term “bakery mixture” may include, for example, a dough, a batter, a mixture, a solution, an emulsion and the like.

The bakery mixture used to form the baked goods may be a modified conventional bakery mixture and may be cooked by conventional baking methods, for example, using ambient heat. In some embodiments, the baked good may contain or be composed of various non-leavened additives such as fruits, meats, cream fillings, nuts, candies, cheeses and/or the like. Alternatively, the baked good may be an egg- or dairy-based baked good, such as a flan, custard, or pudding.

In an embodiment it is preferred that the baked good is, for example, a sticky bun, a dinner roll, a cake, a chocolate cake, a croissant, an upside-down fruit cake (such as an upside-down pineapple cake or peach cake), a tarte tatin, a fruit based dessert (such as cobbler or crumble), a brownie, a brioche, a fruit filling-in-pastry baked good, a flan, a half and half flan/cake type baked good (for example, a “choco-flan” cake).

The baked good may be a single serving baked good (such as for example, a single sticky bun or a single dinner roll) or it may be 2-10 servings (such as for example an entire conventional sized cake or a series of break-apart yeast rolls (e.g., Parker House-style rolls or sticky buns)).

In an embodiment, each of the baked good and the coating liquid is independently prepared to have an a_{w} of about 0.65 to about 0.95, about 0.70 to about 0.85 or about 0.75 to about 0.80. If the baked good and/or the coating liquid is to be maintained at room temperature for a duration of time, it may be preferred that the a_{w} of each of the baked good and the coating liquid is independently below 0.91 to discourage microbial growth.

Additionally, it may be preferred that each of the baked good and the coating liquid is independently prepared to have a moisture content of about 10% to about 30%, about 15% to about 25% or about 20%.

The baked good is disposed in a container that has at least a bottom panel upon which the baked good is placed and the coating liquid is disposed. In some embodiments, the container may be the same container in which the batter was baked by conventional ambient heat methods. In alternative embodiments, the baked good is transferred to the container after conventional baking.

The container may be any three dimensional shape; however, it is preferred that the top area of the container permits access to the baked good. In some embodiments, a container having at least one or at least four sidewalls attached to the bottom panel and an open top area may be preferred. Suitable containers include those having the structure of a four-sided box. Other alternatives may include containers with removable or detachable lids.

The container may be made of any material known or to be developed in the art, so long as such container is suitable for food contact when exposed to microwave energy. In some embodiments, it may be preferred that the container is conventional oven-proof as well as being microwavable and/or is made of a disposable or recyclable material.

Suitable materials may include, for example, paper, wood, porcelains, clay or clay-derived materials, ceramics, laminated materials (e.g., paper or polymer coated foils), bamboo or bamboo derived materials, polyvinyl chloride polymers or copolymers, low density polyethylene polymers and/or copolymers, high-density polyethylene polymers or copolymers, polypropylene polymers or copolymers, polyethylene terephthalate polymers or copolymers, polystyrene, and silicone rubber. Ceramics, metals, metal foils or paper laminates may be used. The container may be disposable, reusable, and/or recyclable.

Upon assembly of the baked good within the container with the coating liquid, the container may be secondarily wrapped, for example, in a plastic film to prevent dehydration of the product during storage or to label or enhance the marketing aesthetics of the bakery foodstuff.

However, in an alternative embodiment, the baked good, the coating liquid and the container may be separately maintained until the microwave energy exposure step or the heat exposure step. At such time, the coating liquid may be placed in the container, followed by the baked good. In another embodiment, the coating liquid may be maintained in the container, and the baked good sequestered separately. If such embodiment is employed, it is preferred that the baked good and the coating liquid are maintained at substantially the same temperature.

Regardless, once prepared the baked good and coating liquid components may be maintained or stored for a duration of time. The extent of time that they can be safely maintained/stored will vary depending on the on the interaction of numerous variables, e.g., the presence/absence of preservatives in the baked good or liquid coating, the water activity of the baked good or liquid coating, the temperature at which the foodstuff is maintained, etc. However, it may be desirable that the baked good and coating liquid are maintained for about 1 day to about 2000 days, for about 1 day to about 365 days, or for about 90 days to about 200 days.

The baked good may be maintained at about room temperature, for example, a temperature of 70° F. to about 75° F. or, less than about 70° F. It may be preferred, however, that the bakery foodstuff is maintained at a cool or cold temperature, such as, for example, about 45° F. or less or about 0° F. or less.

Subsequently, the baked good and coating liquid within the container are exposed to microwave energy or other rapid heating/cooking energies known or to be developed. The duration of exposure will vary depending on the mass of the baked good. For single serve sized portions, however, the duration may preferably be about 30 seconds to about 120 seconds, about 10 seconds to about 60 seconds. It may be desirable that the exposure time is sufficient to increase the temperature of each of the baked good and the coating liquid to a final temperature of about 100° F., or 110° F. to about 160° F. In some embodiments the baked good and coating liquid within the container are exposed to heat in a conventional oven. Such exposure may be brief: about 1 to about 10 minutes, about 5 to about 7 minutes, or less than 10 minutes. Temperatures of the oven may range from about 300° F. to about 375° F.

Upon removal from the microwave oven or other rapid cook device, the container is inverted to release the baked good and the coating liquid which, upon inversion, forms a coating or layer on the baked good by flowing downward.

Also include within the scope of the invention are bakery foodstuff that can be prepared by the consumer on demand and which exhibit the organoleptic properties of conventional freshly baked foodstuffs. Such bakery foodstuffs may be prepared by any of the methods disclosed or claimed herein.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of preparing a consumable on demand, warm bakery foodstuff comprising
(a) preparing a coating fluid;
(b) forming a baked good from a bakery mixture by applying ambient heat, wherein the baked good is disposed in a container comprising at least a bottom panel and a top area through which the baked good is accessible and having disposed upon a top surface of the bottom panel a determinate amount of coating fluid;
(c) maintaining the baked good within the container for a determinate amount of time at a first temperature;
(d) exposing the baked good within the container to an energy for a duration of time sufficient to bring at least the baked good from a second temperature to a final temperature of at least about 100° F.; and
(e) inverting the container to release the baked good through the top areas of the container and the coating liquid, wherein upon inversion, the coating liquid forms a coating on the inverted baked good.

2. The method of claim 1, wherein at step (c), each of the coating liquid and the baked good independently has: an a_{w} of about 0.65 to about 0.95 and a moisture content of about 10% to about 30%.

3.-7. (canceled)

8. The method of claim 1, wherein the container comprises at least one material selected from the group consisting of paper, polyvinyl chloride polymers or copolymers, low density polyethylene polymers and/or copolymers, high-density polyethylene polymers or copolymers, and polypropylene polymers or copolymers.

9. The method of claim 1, wherein the container comprises at least one material selected from the group consisting of polyethylene terephthalate polymers or copolymers, polystyrene, and silicone rubber,

10.-11. (canceled)

12. The method of claim 1, wherein the baked good is maintained at a first temperature of less than or equal to about 70° F.

13.-14. (canceled)

15. The method of claim 1, wherein the second temperature is about 10° F. to about 20° F.

16. The method of claim 1, wherein the second temperature is less than or equal to about 70° F.

17.-18. (canceled)

19. The method of claim 1, wherein the first temperature and the second temperature are substantially the same.

20. The method of claim 1, wherein the final temperature is about 110° F. to about 160° F.

21. The method of claim 1, wherein the duration of time is about 10 seconds to about 60 seconds.

22. The method of claim 1, wherein the a_{w} is about 0.70 to about 0.85.

23. (canceled)

24. The method of claim 1, wherein the baked good is selected from the group consisting of a sticky bun, a brownie, a brioche, a tarte tatin, a fruit filling-in-pastry baked good, a cake, a chocolate cake, a pineapple upside-down cake, cherry cake, a flan and a dinner roll.

25. (canceled)

26. A consumable on demand, warm bakery foodstuff prepared by the method of claim 1.

27. The foodstuff of claim 26, wherein the baked good is selected from the group consisting of a sticky bun, a brownie, a brioche, a tarte tatin, a fruit filling-in-pastry baked good, a cake, a chocolate cake, a pineapple upside-down cake, cherry cake, a flan and a dinner roll.

28. The foodstuff of claim 27, wherein the coating liquid is selected from the group consisting of a caramel sauce, a vanilla, sauce, a fruit sauce, a chocolate sauce, a butter sauce, a garlic sauce, an olive oil sauce and a brandy sauce.

29. A method of manufacture of a warm, consumable on demand bakery foodstuff comprising (a) preparing a coating fluid; (b) forming a baked good from a bakery mixture by applying ambient heat, wherein the baked good is disposed in a container comprising at least a bottom panel and a top area through which the baked good is accessible and having disposed upon a top surface of the bottom panel a determinate amount of coating fluid; (c) maintaining the baked good within the container for a determinate amount of time; wherein, upon exposure to microwave energy and removal from the container by inversion of the container, the baked good exhibits organoleptic properties comparable to a conventional freshly baked bakery foodstuff.

30.-36. (canceled)

37. The method of claim 29, wherein each of the coating liquid and the baked good independently has: an a_{w} of about 0.65 to about 0.95 and a moisture content of about 10% to about 30%.

38. The method of claim 29, wherein the a_{w} is about 0.70 to about 0.85.

39. (canceled)

40. A warm, consumable on demand bakery foodstuff prepared by exposing a baked good disposed in a container comprising at least a bottom panel and a top area through which the baked good is accessible and having disposed upon a top surface of the bottom panel a determinate amount of coating fluid to microwave energy for a duration of time sufficient to bring at least the baked good from a first temperature to a temperature of at least about 100° F. and inverting the container to release the baked good through the top areas of the container and the coating liquid, wherein upon inversion, the coating liquid forms a coating on the inverted baked good; wherein at step (c), each of the coating liquid and the baked good independently has: an a_{w} of about 0.65 to about 0.95 and a moisture content of about 10% to about 30%.
